(19) United States
(12) Patent Application Publication
(10) Pub. No.: US 2018/0121499 A1
(43) Pub. Date: May 3, 2018

(54) Targeted Mentions for User Correlation to a Search Term

(71) Applicant: Microsoft Technology Licensing, LLC, Redmond, WA (US)

(72) Inventors: Anand Kumar Joshi, Bellevue, WA (US); William James Bliss, Bellevue, WA (US)

(73) Assignee: Microsoft Technology Licensing, LLC, Redmond, WA (US)

(21) Appl. No.: 15/370,714

(22) Filed: Dec. 6, 2016

Related U.S. Application Data
(60) Provisional application No. 62/416,037, filed on Nov. 1, 2016.

(51) Int. Cl. G06F 17/30

(52) U.S. Cl. CPC G06F 17/30401; G06F 17/3053

(57) ABSTRACT

Techniques for targeted mentions for user correlation to a search term are described. According to various implementations, users interact over a network-based service to engage in conversations (e.g., text, voice, video, and so forth), exchange content, collaborate on projects, and so forth. In the course of these interactions, users that author content and/or interact with content can discuss certain subject matter and can tag (“targeted mention”) certain users as being knowledgeable in the subject matter. The targeted mention is then discoverable during a search process to surface a correlation between a particular user and the particular subject matter.

### RELATED APPLICATIONS

This application claims priority under 35 U.S.C. Section 119(e) to U.S. Provisional Patent Application No. 62/416,037, filed Nov. 1, 2016 and titled “Targeted Mentions for User Correlation to a Search Term,” the entire disclosure of which is hereby incorporated by reference.

### BACKGROUND

Today's online environment provides access to an enormous amount of content. Searching through such content for meaningful information presents a number of challenges, both from a system resources and user interaction perspectives. Further, current search techniques typically utilize direct searching methods, such as finding a document with a keyword associated with the document, or finding a person based on their name or address.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for targeted mentions for user correlation to a search term are described. According to various implementations, users interact over a network-based service to engage in conversations (e.g., text, voice, video, and so forth), exchange content, collaborate on projects, and so forth. In the course of these interactions, users that author content and/or interact with content can discuss certain subject matter and can tag (“targeted mention”) certain users as being knowledgeable in the subject matter. The targeted mention is then discoverable during a search process to surface a correlation between a particular user and the particular subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein in accordance with one or more implementations.

FIG. 2 depicts an example implementation scenario for linking users to particular subject matter in accordance with one or more implementations.

FIG. 3 depicts an example implementation scenario for searching for correlations between users and a topic in accordance with one or more implementations.

FIG. 4 is a flow diagram of an example method for generating a ranked set of users associated with a search term in accordance with one or more implementations.

FIG. 5 is a flow diagram of an example method for presenting content associated with a targeted mention of a user in accordance with one or more implementations.

FIG. 6 is a flow diagram of an example method for calculating a correlation score for a user in accordance with one or more implementations.

FIG. 7 illustrates an example system and computing device such as described with reference to FIG. 1, which are configured to implement implementations of techniques described herein.

### DETAILED DESCRIPTION

Techniques for targeted mentions for user correlation to a search term are described. According to various implementations, users interact over a network-based service to engage in conversations (e.g., text, voice, video, and so forth), exchange content, collaborate on projects, and so forth. Examples of such interactions include email, chat conversations, social media posts, voice/video calls, online collaboration sessions, Internet messaging (IM), and so forth. In the course of these interactions, users that author content and/or interact with content can discuss certain subject matter and can tag certain users as likely having insight into and/or being knowledgeable in the subject matter. A user, for instance, can generate a “targeted mention” of a different user by tagging a user identifier with a particular symbol or phrase, which links the user identifier to subject matter being discussed. For example, a user that knows of a different user that is knowledgeable in a particular topic being discussed can create a targeted mention of the different user as part of the discussion. The targeted mention is then discoverable during a search process to surface a correlation between the “expert” user and the particular subject matter.

According to various implementations, content generated during user interactions and that includes targeted mentions can be searched to identify correlations between users and search terms. Further, criteria other than targeted mentions may be used to determine correlations between users and search terms. Examples of such other criteria include content that is authored by a user and that includes the search term, content that includes a search term and in which a user is referenced but not specifically target mentioned, and so forth. Thus, content that includes both targeted mentions of a user and a search term may be considered along with other content associated with the user that includes the search term but does not include a targeted mention of the user in determining a correlation between the search term and the user.

According to various implementations, users can be scored with regard to how strongly the different users are correlated to a particular search term. For instance, a user that is identified as having the most targeted mentions for a particular search term can be given a highest score amongst a set of users, and thus can be ranked first among the users in a set of search results. As further detailed below, factors other than targeted mentions can be considered in scoring users, and individual factors such as targeted mentions can be weighted in different ways to determine to what extent the factors affect a user's overall correlation score.

Accordingly, techniques for targeted mentions for user correlation to a search term provide efficient ways for storing correlations between users and relevant subject matter, and also for searching for and discovering such correlations. Thus, system resources such as processor time, network bandwidth, and server resources are conserved in comparison with traditional search algorithms by reducing a number and complexity of searches required to enable a user to identify another user that may have information of interest. Further, user engagement and satisfaction with a search experience are increased in comparison with traditional search algorithms by reducing the number of user interactions required to discover users of interest.

In the following discussion, an example environment is first described that is operable to employ techniques described herein. Next, some example implementation scenarios are presented in accordance with one or more implementations. Following this, some example procedures are discussed in accordance with one or more implementations. Finally, an example system and device that are operable to employ techniques discussed herein in accordance with one or more implementations.

Having presented an overview of example implementations in accordance with one or more implementations, consider now an example environment in which example implementations may by employed.

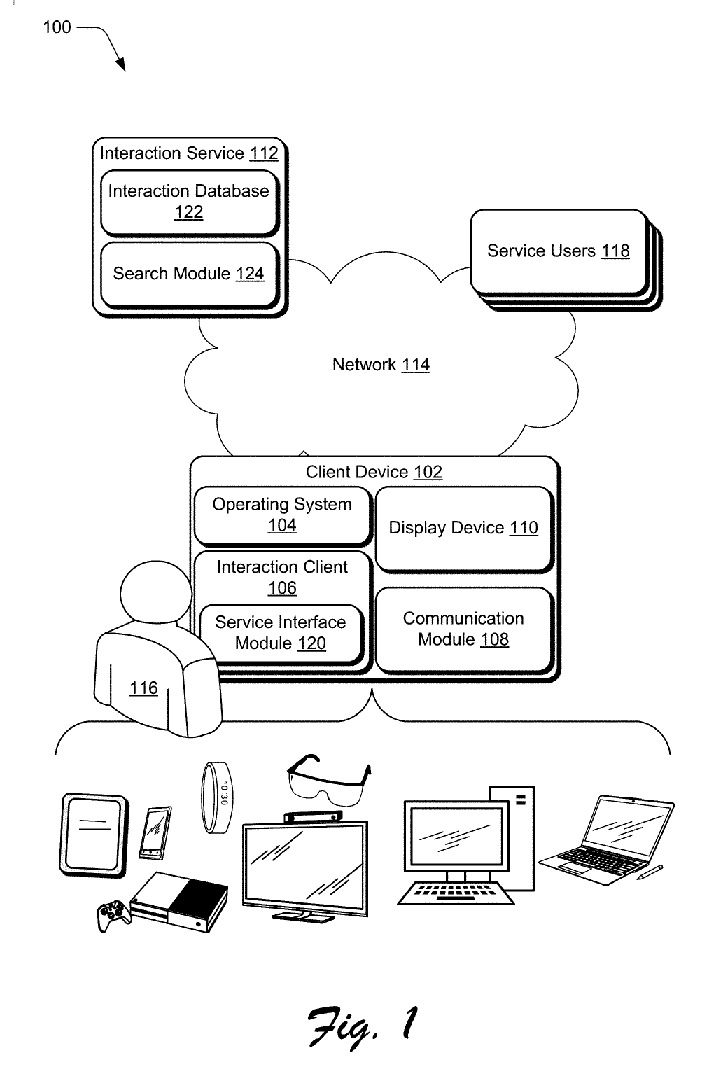

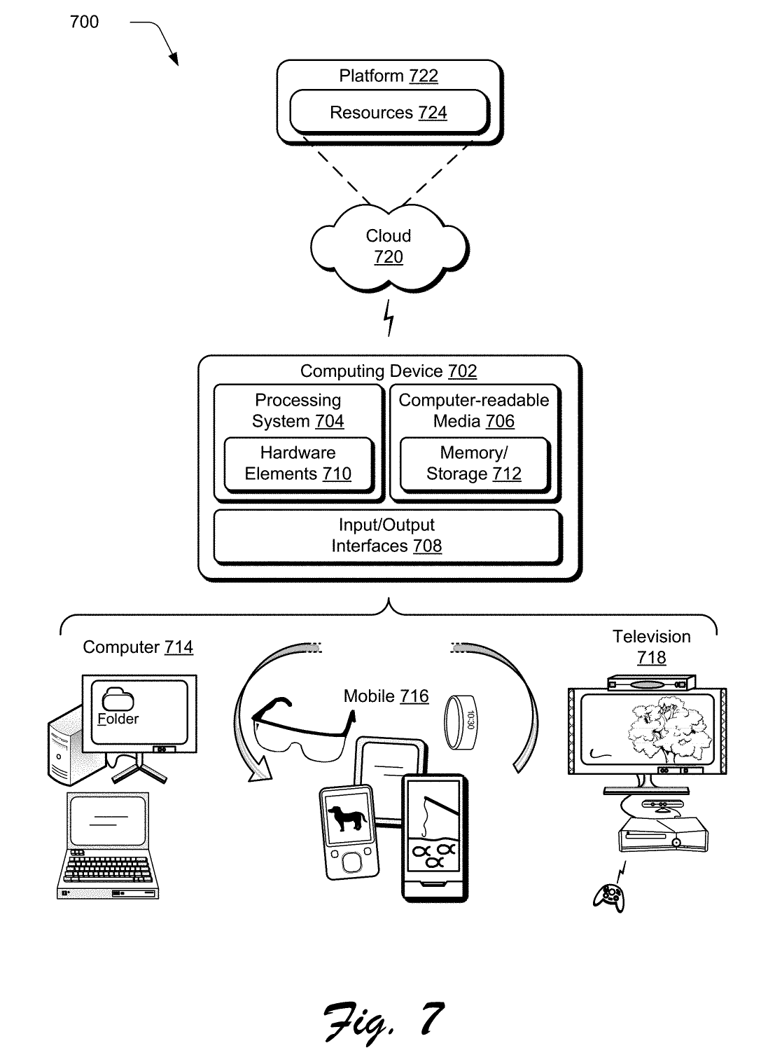

FIG. 1 is an illustration of an environment 100 in an example implementation that is operable to employ techniques for targeted mentions for user correlation to a search term discussed herein. Environment 100 includes a client device 102 which can be implemented as any suitable device such as, by way of example and not limitation, a smartphone, a tablet computer, a portable computer (e.g., a laptop), a desktop computer, a wearable device, combinations of devices, and so forth. Thus, the client device 102 may range from a system with significant processing power, to a lightweight device with minimal processing power. One of a variety of different examples of a client device 102 is shown and described below in FIG. 7.

The client device 102 includes a variety of different functionalities that enable various activities and tasks to be performed. For instance, the client device 102 includes an operating system 104, an interaction client 106, a communication module 108, and a display device 110. Generally, the operating system 104 is representative of functionality for abstracting various system components of the client device 102, such as hardware, kernel-level modules and services, and so forth.

The interaction client 106 represents functionality for accessing an interaction service 112 via a network 114. Generally, the interaction service 112 represents a network-based service that is remote from the client device 102 and that enables interaction between a user 116 of the client device 102 and other service users 118. Examples of the interaction service 112 include a chat service, a collaboration service, a meeting service, an email service, a social media service, and so forth. The user 116 and the service users 118, for instance, interact via the interaction service 112 to communicate via various modalities (e.g., text chat, audio, video, and so forth), exchange content, engage in business transactions, and so on.

According to various implementations, the interaction client 106 may be installed locally on the client device 102 to be executed via a local runtime environment, and/or may represent a portal to remote functionality hosted by the interaction service 112. Thus, the interaction client 106 may take a variety of forms, such as locally-executed code, a portal to remotely hosted services, and so forth.

The communication module 108 is representative of functionality for enabling the client device 102 to communication over wired and/or wireless connections to the network 114. For instance, the communication module 108 represents hardware and logic for communication via a variety of different wired and/or wireless technologies and protocols.

The interaction client 106 includes a service interface module 120, which is generally representative of functionality for generating a graphical user interface (GUI) to enable the user 116 to interact with the service users 118 via the interaction service 112.

As further depicted in the environment 100, the interaction service 112 includes an interaction database 122 and a search module 124. The interaction database 122 represents functionality for storing various content for the interaction service 112. Examples of such content include emails, chat posts, shared files and other shared media, Internet messages (IMs), and so forth. As further detailed below, the search module 124 represents functionality for searching the interaction database 122 to discover correlations between users and different subject matter, such as in response to search terms entered via the service interface module 120 and submitted by the interaction client 106 to the interaction service 112.

The display device 110 generally represents functionality for visual output for the client device 102. Additionally, the display device 110 represents functionality for receiving various types of input, such as touch input, pen input, and so forth. The network 114 may be implemented in various ways, such as a wired network, a wireless network, and combinations thereof. In at least some implementations, the network 114 represents the Internet.

Having described an example environment in which the techniques described herein may operate, consider now a discussion of some example implementation scenarios in accordance with one or more implementations.

This section describes some example implementation scenarios for targeted mentions for user correlation to a search term in accordance with one or more implementations. The implementation scenarios may be implemented in the environment 100 described above, the system 700 of FIG. 7, and/or any other suitable environment. The implementation scenarios and procedures, for example, describe example operations of the client device 102 and/or the interaction service 112. While the implementation scenarios are discussed with reference to a particular application (e.g., the interaction client 106), it is to be appreciated that techniques for targeted mentions for user correlation to a search term discussed herein are applicable across a variety of different applications, services, and environments.

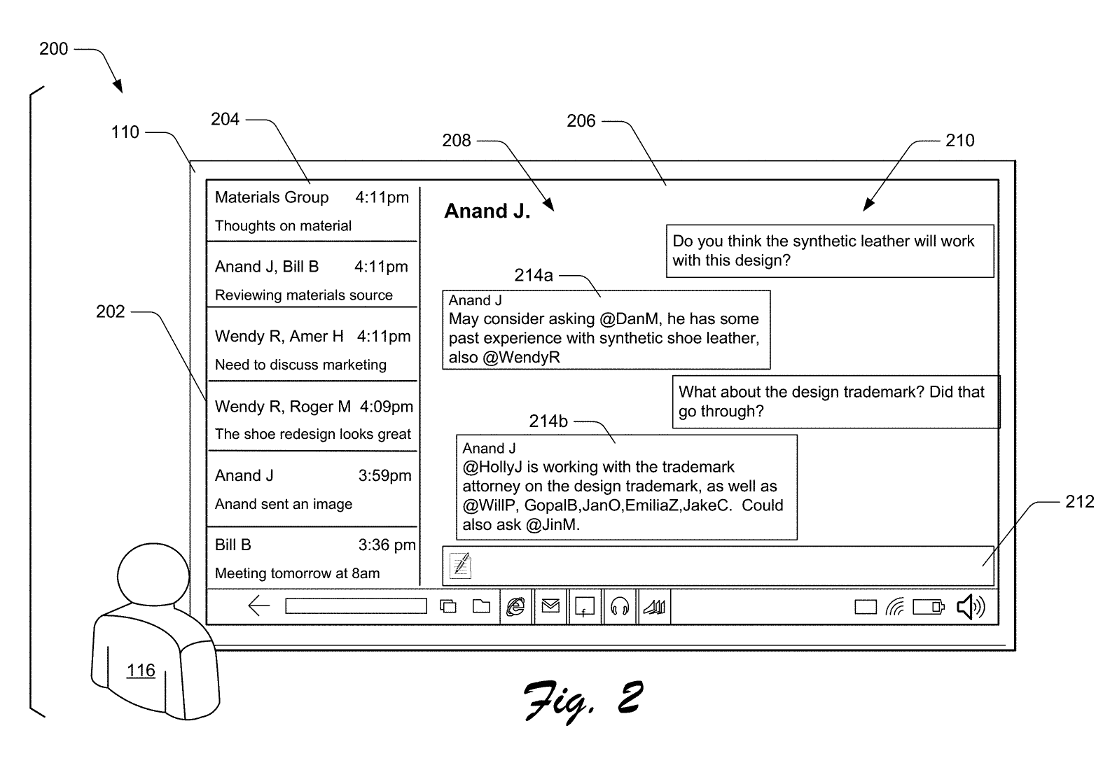

FIG. 2 depicts an example implementation scenario 200 for linking users to particular subject matter in accordance with one or more implementations. The scenario 200 includes an interaction GUI 202 which enables the user 116 to interact with other service users 118 in various ways. The interaction GUI 202, for instance, is generated by the service interface module 120 for the interaction client 106, and is displayed on the display device 110.

In this particular implementation, the interaction GUI 202 enables the user 116 to engage in chat conversations with different service users 118. For instance, the interaction GUI 202 includes an interaction history region 204 and a current conversation region 206. The interaction history region 204 lists different interaction sessions (e.g., chat sessions) that the user 116 has participated in and/or is currently participating in. The current conversation region 206 includes chat content for a current ongoing chat session between the user 116 and a service user “Anand J.” For instance, the left portion 208 of the current conversation region 206 includes chat content received from Anand J., and the right portion 210 of the current conversation region 206 includes chat content input by the user 116 to the interaction GUI 202.

The current conversation region 206 also includes an input region 212, which represents a region in which the user 116 can input content as part of a current chat conversation. For instance, text content input to the input region 212 by the user 116 is populated to the right portion 210 as part of the ongoing chat session.

Further to the scenario 200, content received from Anand J. as part of the chat conversation includes a chat entry 214a and a chat entry 214b. Notice that the chat entry 214a includes text discussing a certain topic (“synthetic shoe leather”) as well as targeted mentions “@DanM” and “@WendyR.” According to techniques for targeted mentions for user correlation to a search term described herein, these targeted mentions represent a way of linking users to particular subject matter. For example, a targeted mention represents an input by one user of a mention of a different user, such as to indicate that the different user has some knowledge of and/or insight into a particular topic and/or subject matter.

In this particular implementation, the targeted mentions include a search tag (“@”) followed by user identifiers “DanM” and “WendyR.” Generally, the search tag represents a symbol or phrase that serves as a search affordance for linking specific user identifiers to subject matter included in a post. In this particular example, the targeted mentions function to link keywords and/or topic information from the chat entry 214a to the users DanM and WendyR. Further, the targeted mentions are included in the body of the chat entry 214a, as opposed to other areas such as an address field. As further detailed below, this linkage enables users to search for and discover correlations between particular users and particular subject matter.

Continuing with the scenario 200, the chat entry 214b includes other subject matter (e.g., “trademark attorney” and “design trademark”) as well as several different targeted mentions. Similarly to the chat entry 214a, these targeted mentions function to link associated users with subject matter discussed in the chat entry 214b. In this particular example, the chat entry 214b includes numerous targeted mentions, i.e., more than that of the chat entry 214a. In at least some implementations, a number of targeted mentions linked to particular subject matter can affect a weight attributed to the individual targeted mentions for purposes of ranking correlations between individual users and the subject matter. As further detailed below, different weights attributed to different targeted mentions affects how different users are ranked as being correlated to (e.g., “experts in”) a particular topic.

According to various implementations, correlations between targeted mentions and topic information included in different interaction sessions is extracted and stored as part of the interaction database 122. The interaction service 112, for instance, extracts content from different interaction sessions (e.g., the chat entries 214a, 214b) and stores the content as part of the interaction database 122. As further detailed below, the interaction database 122 is searchable to discover correlations between different users and different interaction content.

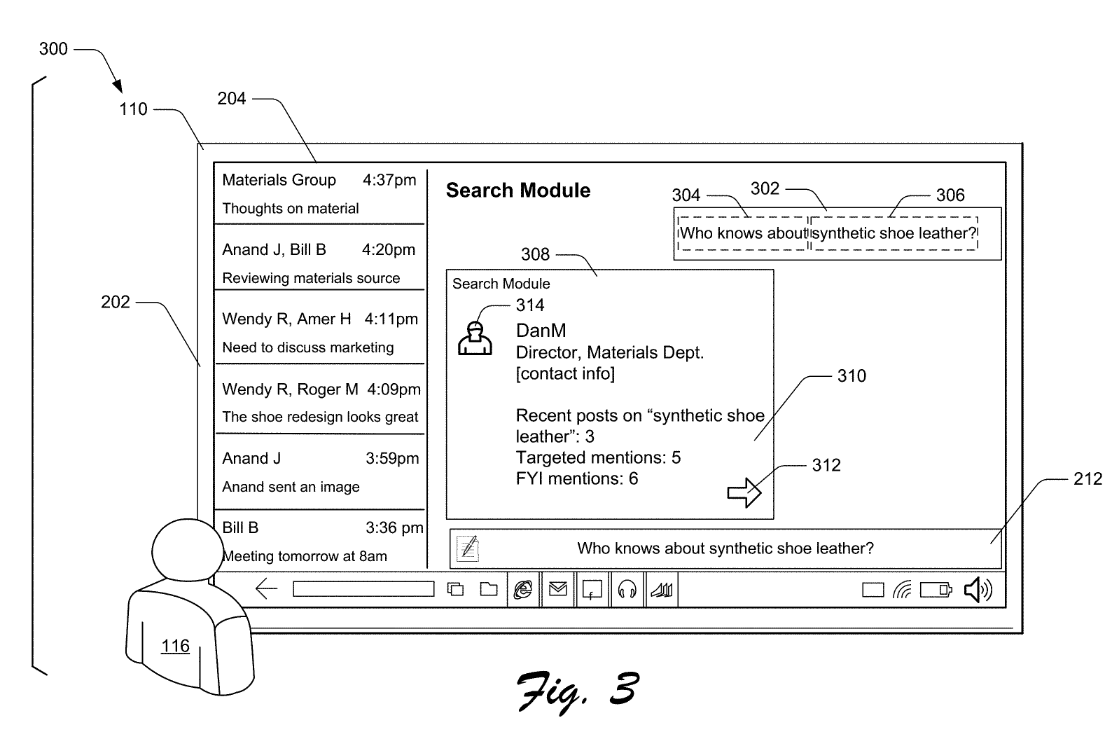

FIG. 3 depicts an example implementation scenario 300 for searching for correlations between users and a topic in accordance with one or more implementations. The scenario 300, for instance, represents an extension of and/or variation on the scenario 200.

The scenario 300 includes the interaction GUI 202 which not only enables the user 116 to interact with other service users 118, but to search the interaction database 122 for interaction content. The user 116, for instance, initiates a search session with the search module 124. Generally, the search session may be initiated in various ways, such as by selecting a contact entry (e.g., an icon) that represents the search module 124, by typing a certain trigger word or phrase into the input region 212, and so forth.

In at least some implementations, the search module 124 implements a bot (e.g., a chat bot) that simulates a chat conversation with the user 116 via the interaction GUI 202. The chat conversation, for instance, enables the user 116 to enter a search query into the interaction GUI 202, and the search module 124 to search the interaction database 122 based on the search query.

Further to the scenario 300, the user 116 enters text representing a search query into the input region 212, which causes a search query 302 to be submitted to the search module 124. The search query 302 includes a trigger phrase 304 (“Who knows about”) and search term 306 (“synthetic shoe leather”). According to implementations discussed herein, the trigger phrase 304 represents a word or phrase that is specified to initiate a search for correlations between users and subject matter relating to the search term 306. For instance, the search module 124 parses the search query 302 to identify the trigger phrase 304 and the search term 306. While the search term 306 is depicted here as text-based, this is not intended to be limiting. A search term, for instance, may take a variety of forms alternatively or additionally to text, such as an image, audio, video, and so forth.

Accordingly, the search module 124 recognizes the trigger phrase 304 as a request to initiate a search for correlations between users and the search term 306. The search module 124 then initiates a search of the interaction database 122 to discover correlations between users and the search term 306. For instance, the search module 124 searches content that has been posted via the interaction service 112 for correlations between specific user identifiers and the search term 306. The search module 124, for example, searches for targeted mentions in posts that include the search term 306. In at least some implementations, the targeted mentions represent a search tag (e.g., the “@” symbol) linked to (e.g., appended to) specific user identifiers. The search module 124 may also search for other indications of such correlations, such as authors of posts that include the search term 306, participants in conversations that include the search term 306, users that are cc′d in posts (e.g., emails) that include the search term 306, and so forth.

Based on the search, the search module 124 returns search results 308. In this particular example, the search results 308 visually simulate a chat entry by the search module 124. Further, the search results 308 identify different users that the search module 124 determines are correlated with the search term 306. For instance, the search results 308 indicate that a user “DanM” is correlated with the search term 306, and include various information about DanM such as position in a company, contact info, and so forth.

The search results 308 also include correlation information 310 that describes how the user DanM is correlated to the search term 306. For instance, the correlation information 310 indicates that DanM has authored three recent posts that include the search term 306, has five targeted mentions (e.g., “@DanM”) in posts that include the search term 306, and has six secondary (“FYI”) mentions in posts that include the search term 306. Generally, a secondary mention represents a post in which a user is not an author and is not a targeted mention, but has been identified in some other way as being linked to subject matter that includes the search term 306. Examples of a secondary mention include being cc′d in an email that includes the search text, being a recipient (i.e., not an author) of a post that includes the search term 306, being referenced (but not targeted mentioned) in a post that includes the search term 306, and so forth.

As further detailed below, different instances of the correlation information 310 can be weighted differently for purposes of calculating a correlation score that indicates how strongly a particular user is correlated to a search term, e.g., the search term 306. A user with a higher correlation score, for instance, is consider more strongly correlated with a search term than a different user with a lower correlation score. For example, a user with a higher correlation score is a higher ranked search result than a different user with a lower correlation score, and thus is prioritized over (e.g., presented before) the different user in a set of search results. The user with the higher correlation score, for instance, may be labeled by the interaction service 112 as an “expert” in particular subject matter pertaining to the search term 306.

For instance, consider that in the scenario 300, DanM is determined to have a highest correlation score among a group of users identified as being correlated with the search term 306. Accordingly, DanM is presented in a primary position in the search results 308. Notice that the search results 308 include an index control 312. Generally, the index control 312 is selectable to index (e.g., scroll) through the search results 308 and view information about different users that are determined to be correlated to the search term 306. For example, selecting the index control 312 causes the search results 308 to scroll through different users in descending order of correlation score, i.e., highest to lowest. As with the user DanM, correlation information can be presented for each of the users that indicates how each user is correlated to the search term 306.

According to one or more implementations, content associated with the search results 308 can be retrieved and displayed. For instance, selecting a user icon 314 that represents DanM can cause different content associated with the correlation information 310 (e.g., posts to the interaction service 112) to be retrieved and displayed, such as in the interaction GUI 202.

Having discussed some example implementation scenarios, consider now some example procedures in accordance with one or more implementations.

The following discussion describes some example procedures for sharing across environments in accordance with one or more implementations. The example procedures may be employed in the environment 100 of FIG. 1, the system 700 of FIG. 7, and/or any other suitable environment. The procedures, for instance, represent procedures for implementing the example implementation scenarios discussed above. In at least some implementations, the steps described for the various procedures can be implemented automatically and independent of user interaction. The procedures may be performed locally at the client device 102, by the interaction service 112, and/or via interaction between the client device 102 and the interaction service 112. This is not intended to be limiting, however, and aspects of the methods may be performed by any suitable entity.

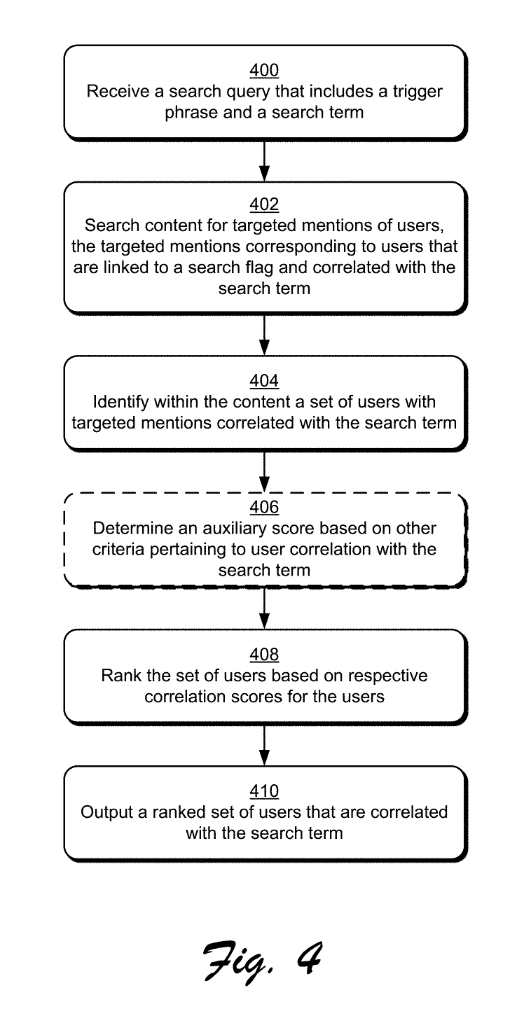

FIG. 4 is a flow diagram that describes steps in a method in accordance with one or more implementations. The method describes an example procedure for generating a ranked set of users associated with a search term in accordance with one or more implementations.

Step 400 receives a search query that includes a trigger phrase and a search term. A user, for instance, inputs a search query that includes a trigger phrase and a search term, examples of which are discussed above. Generally, a trigger phrase represents a word or set of words that is recognized as triggering a particular action, in this case a search of content. A trigger phrase may be input in various ways, such as via text input, voice input, gesture input, and so forth. In at least some implementations, the search query is received by the interaction client 106, such as via the interaction GUI 202. Further, the search module 124 can parse the search query, recognize the trigger phrase, and separate the trigger phrase from the search term included in the search query.

Step 402 searches content for targeted mentions of users, the targeted mentions corresponding to users that are linked to a search tag and correlated with the search term. The content search, for instance, is initiated automatically (e.g., by the search module 124) in response to detecting the trigger phrase. In at least some implementations, the search is initiated via interaction between the interaction client 106 and the interaction service 112.

Generally, the search tag is different than the search term. The search tag, for instance, corresponds to a symbol, term, phrase, and so on, that is appended to user identifiers within content. For example, the search tag is pre-configured as being indicative of a certain condition, such as a targeted mention of a particular user ID.

Step 404 identifies within the content a set of users with targeted mentions correlated with the search term. The search module 124, for example, searches the interaction database 122 for posts and other instances of content that include both targeted mentions of users and the search term.

Step 406 determines an auxiliary score based on other criteria pertaining to user correlation with the search term. Generally, “other criteria” refers to criteria other than targeted mentions. Examples of such other criteria include content authored by the user that includes the search term, secondary mentions of the user in content that includes the search term, and so forth. In at least some implementations, step 406 is optional.

Step 408 ranks the set of users based on respective correlation scores for the users. For instance, a correlation score is calculated for each user that indicates how strongly each user is correlated to the search term. Generally, the correlation scores are based at least in part on a number of targeted mentions for individual users of the set of users. The correlation scores may be based on other criteria as well, such as the auxiliary score determined above.

Step 410 outputs a ranked set of users that are correlated with the search term. The set of users, for instance, is presented with highest ranked user first and with other users presented in descending order of correlation score. In at least some implementations, the ranked set of users is displayed as part of the interaction GUI 202.

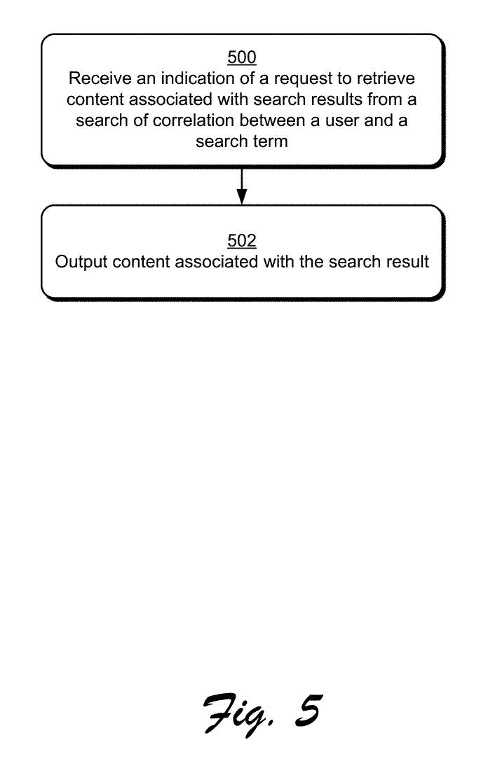

FIG. 5 is a flow diagram that describes steps in a method in accordance with one or more implementations. The method describes an example procedure for presenting content associated with a targeted mention of a user in accordance with one or more implementations. In at least some implementations, the method describes an example extension of the method described above with reference to FIG. 4.

Step 500 receives an indication of a request to retrieve content associated with search results from a search of correlations between a user and a search term. A user, for instance, provides input to request content associated with a search result from the ranked set of users discussed above.

Step 502 outputs content associated with the search result. The search module 124, for example, presents different instances of content that were located as part of the search discussed above. In at least some implementations, the content represents content in which targeted mentions of a particular user occur. Examples of the content include emails, chat posts, images, and so forth, that include the search term and targeted mentions of the user. The content may be output in various ways, such as via display as part of the interaction GUI 202.

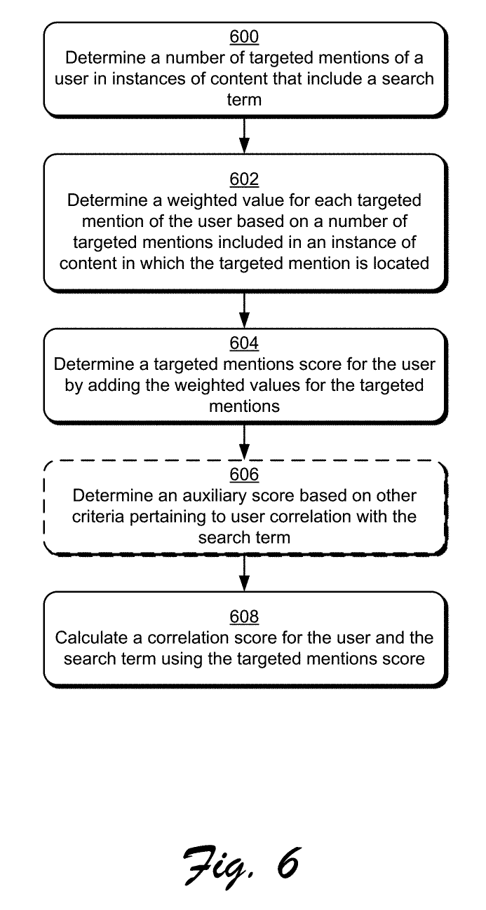

FIG. 6 is a flow diagram that describes steps in a method in accordance with one or more implementations. The method describes an example procedure for calculating a correlation score for a user in accordance with one or more implementations.

Step 600 determines a number of targeted mentions of a user in instances of content that include a search term. Generally, an instance of content corresponds to a discrete piece of content, such as a single chat entry in a chat conversation, a single email and/or email thread, an instance of an online meeting, a single Internet message (IM), and so forth.

Step 602 determines a weighted value for each targeted mention of the user based on a number of targeted mentions included in an instance of content in which the targeted mention is located. The search module 124, for instance, determines a number of targeted mentions of different users that occur in each instance of content in which the user has a targeted mention. The search module 124 then ascertains whether targeted mentions of different users in any of the instances of content exceed a threshold number of targeted mentions. For example, multiple different users may have targeted mentions in a single instance of content. Any number of targeted mentions may be specified as a threshold, such as 5, 8, 10, and so forth. If a number of targeted mentions in an instance of content exceeds the threshold, a weighted value for a targeted mention of the user found in the instance of content is reduced.

For instance, a standard weighted value of one (“1”) is applied to a targeted mention that is found in an instance of content that includes a search term and that includes less than the threshold number of targeted mentions. However, the standard weighted value is reduced for a targeted mention that is found in an instance of content that includes the search term but that exceeds the threshold number of targeted mentions. The reduced weighted value, for instance, may be 0.5. According to various implementations, reducing a weighted value for such targeted mentions reflects the notion that when many targeted mentions occur in an instance of content, this may reduce the impact of a single targeted mention amongst the group of targeted mentions. Thus, in a collection of search results, different targeted mentions may be afforded different weighted values based on numbers of targeted mentions in instances of content associated with the search results.

Step 604 determines a targeted mentions score for the user by adding the weighted values for the targeted mentions. For instance, standard and adjusted weighted values are added (e.g., summed) to obtain an overall targeted mentions score for the user and for a particular search term. Thus, targeted mentions that have reduced weighted values based on a number of associated weighting values will have a reduced impact on the overall targeted mentions score.

Step 606 determines an auxiliary score based on other criteria pertaining to user correlation with the search term. Generally, “other criteria” refers to criteria other than targeted mentions. Examples of such other criteria include content authored by the user that includes the search term, secondary mentions of the user in content that includes the search term, and so forth. In at least some implementations, each instance of content authored by the user that includes the search term is given a weighted value that is higher than that afforded to individual targeted mentions. An instance of authored content, for instance, may be given a weighted value of two. According to various implementations, applying a higher weighted value to authored content reflects the notion that when a user authors content that includes a search term, this may be indicative that the user has some knowledge about subject matter pertaining to the search term.

Further, a secondary mention of the user in content that includes the search term can be given a lower weighted value, e.g., 0.5. This generally reflects the notion that a secondary mention may be incidental (e.g., FYI to the user) and does not necessarily indicate direct involvement and/or knowledge concerning a search term.

According to one or more implementations, an auxiliary score can be determined using content that does not include a targeted mention. For instance, content that is generated (e.g., authored) by particular user and that includes the search term can be used to generate an auxiliary score for the user even if the content does not include a targeted mention of the user. Thus, content that includes both targeted mentions of a user and a search term may be considered along with other content associated with the user that includes the search term but does not include a targeted mention of the user in determining a correlation score for the user.

In at least some implementations, step 606 is optional and thus a correlation score may be calculated based on a targeted mentions score and not an auxiliary score.

Step 608 calculates a correlation score for the user and the search term using the targeted mentions score. The targeted mentions score, for instance, may be considered separate from an auxiliary score in calculating the correlation score. Alternatively, an auxiliary score may also be considered. The search module 124, for instance, adds the targeted mentions score and the auxiliary score to obtain a correlation score for the user and the search term.

In at least some implementations, a user with a higher correlation score is considered to be more strongly correlated with a search term than a user with a lower correlation score. For instance, a user with a higher correlation score may be designated as an “expert” in a particular topic associated with a search term, whereas a user with a lower correlation score may not. Using the techniques described above, users with high correlation scores for a particular search term may be catalogued by the interaction service 112 as experts in subject matter associated with the search term such that a user may initiate a search for experts in the subject matter without having to perform a subsequent content search as described above.

Having described some example procedures for targeted mentions for user correlation to a search term, consider now a discussion of an example system and device in accordance with one or more implementations.

FIG. 7 illustrates an example system generally at 700 that includes an example computing device 702 that is representative of one or more computing systems and/or devices that may implement various techniques described herein. For example, the client device 102 and/or the interaction service 112 discussed above with reference to FIG. 1 can be embodied as the computing device 702. The computing device 702 may be, for example, a server of a service provider, a device associated with the client (e.g., a client device), an on-chip system, and/or any other suitable computing device or computing system.

The example computing device 702 as illustrated includes a processing system 704, one or more computer-readable media 706, and one or more Input/Output (I/O) Interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 is illustrated as including memory/storage 712. The memory/storage 712 represents memory/storage capacity associated with one or more computer-readable media. The memory/storage 712 may include volatile media (such as random access memory (RAM)) and/or nonvolatile media (such as read only memory (ROM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 710 and computer-readable media 706 are representative of instructions, modules, programmable device logic and/or fixed device logic implemented in a hardware form that may be employed in some implementations to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of modules that are executable by the computing device 702 as software may be achieved at least partially in hardware, e.g., through use of computer-readable storage media and/or hardware elements 710 of the processing system. The instructions and/or functions may be executable/operable by one or more articles of manufacture (for example, one or more computing devices 702 and/or processing systems 704) to implement techniques, modules, and examples described herein.

As further illustrated in FIG. 7, the example system 700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 700, multiple devices are interconnected through a central computing device. The central computing device may be local to the multiple devices or may be located remotely from the multiple devices. In one implementation, the central computing device may be a cloud of one or more server computers that are connected to the multiple devices through a network, the Internet, or other data communication link.

In one implementation, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one implementation, a class of target devices is created and experiences are tailored to the generic class of devices. A class of devices may be defined by physical features, types of usage, or other common characteristics of the devices.

In various implementations, the computing device 702 may assume a variety of different configurations, such as for computer 714, mobile 716, and television 718 uses. Each of these configurations includes devices that may have generally different constructs and capabilities, and thus the computing device 702 may be configured according to one or more of the different device classes. For instance, the computing device 702 may be implemented as the computer 714 class of a device that includes a personal computer, desktop computer, a multi-screen computer, laptop computer, netbook, and so on.

The computing device 702 may also be implemented as the mobile 716 class of device that includes mobile devices, such as a mobile phone, portable music player, portable gaming device, a tablet computer, a wearable device, a multi-screen computer, and so on. The computing device 702 may also be implemented as the television 718 class of device that includes devices having or connected to generally larger screens in casual viewing environments. These devices include televisions, set-top boxes, gaming consoles, and so on.

The techniques described herein may be supported by these various configurations of the computing device 702 and are not limited to the specific examples of the techniques described herein. For example, functionalities discussed with reference to the client device 102 and/or the interaction service 112 may be implemented all or in part through use of a distributed system, such as over a “cloud” 720 via a platform 722 as described below.

The cloud 720 includes and/or is representative of a platform 722 for resources 724. The platform 722 abstracts underlying functionality of hardware (e.g., servers) and software resources of the cloud 720. The resources 724 may include applications and/or data that can be utilized while computer processing is executed on servers that are remote from the computing device 702. Resources 724 can also include services provided over the Internet and/or through a subscriber network, such as a cellular or Wi-Fi network.

The platform 722 may abstract resources and functions to connect the computing device 702 with other computing devices. The platform 722 may also serve to abstract scaling of resources to provide a corresponding level of scale to encountered demand for the resources 724 that are implemented via the platform 722. Accordingly, in an interconnected device implementation, implementation of functionality described herein may be distributed throughout the system 700. For example, the functionality may be implemented in part on the computing device 702 as well as via the platform 722 that abstracts the functionality of the cloud 720.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Techniques for targeted mentions for user correlation to a search term are described. Although implementations are described in language specific to structural features and/or methodological acts, it is to be understood that the implementations defined in the appended claims are not necessarily limited to the specific features or acts described. Rather, the specific features and acts are disclosed as example forms of implementing the claimed implementations.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A system for generating a ranked set of users correlated with a search term, the system comprising: one or more processors; and one or more computer-readable storage media storing computer-executable instructions that, responsive to execution by the one or more processors, cause the system to perform operations including: receiving a search query that includes a trigger phrase and a search term; searching content, based on the trigger phrase, for targeted mentions of users, the targeted mentions corresponding to users that are linked to a search tag and correlated with the search term, the search tag being different than the search term; identifying within the content a set of users with targeted mentions correlated with the search term; ranking the set of users based on respective correlation scores for the users, the correlation scores based at least in part on a number of targeted mentions for individual users of the set of users; and outputting, based on said ranking, a ranked set of users that are correlated with the search term.

In addition to any of the above described systems, any one or combination of: wherein the content includes content posted to a network-based interactivity service wherein the content includes content posted to a network-based interactivity service, and wherein the search query is received via user input to the interactivity service; wherein the content includes content posted to a network-based interactivity service, and wherein the search tag comprises a symbol appended to user identifiers for the users within body portions of the content; wherein said searching comprises searching for the search tag appended to user identifiers for different users, the user identifiers being included in instances of the content that include the search term; further comprising a search module that is configured to parse the search query to distinguish between the trigger phrase and the search term, and to recognize the trigger phrase as a request to initiate said searching; wherein said identifying comprises identifying occurrences of the targeted mentions and the search term together in instances of the content; wherein said ranking comprises determining, for a particular user of the set of users, weighted values for targeted mentions of the particular user, adding the weighted values to determine a targeted mentions score, and determining a correlation score for the particular user based at least in part on the targeted mentions score; wherein said ranking comprises: determining, for a particular user of the set of users, weighted values for targeted mentions of the particular user, a particular weighted value of a particular targeted mention being based on a number of targeted mentions of different users that are included in an instance of the content for the particular targeted mention; and adding the weighted values to determine a targeted mentions score, and determining a correlation score for the particular user based at least in part on the targeted mentions score; wherein said ranking comprises: determining, for a particular user of the set of users, weighted values for targeted mentions of the particular user, a particular weighted value of a particular targeted mention being reduced from a standard weighting value based on a number of targeted mentions of different users that are included in an instance of the content for the particular targeted mention exceeding a threshold number of targeted mentions; and adding the weighted values to determine a targeted mentions score, and determining a correlation score for the particular user based at least in part on the targeted mentions score; wherein said ranking comprises: determining, for a particular user of the set of users, weighted values for targeted mentions of the particular user, and adding the weighted values to determine a targeted mentions score for the particular user; determining an auxiliary score for the particular user based on criteria other than targeted mentions of the particular user, the criteria pertaining to correlation of the particular user with the search term; and using the targeted mentions score and the auxiliary score to determine a correlation score for the particular user.

A method for generating a ranked set of users correlated with a search term, the method comprising: searching content, by a computing device, for targeted mentions of users, the targeted mentions corresponding to users that are linked to a search tag and correlated with a search term, the search tag being different than the search term; ranking a set of users based on respective correlation scores for the users, the correlation scores based at least in part on a number of targeted mentions for individual users of the set of users; and outputting, based on said ranking, a ranked set of users that are correlated with the search term.

In addition to any of the above described methods, any one or combination of: wherein said searching is based on a search query that includes a trigger phrase and the search term, the trigger phrase causing said searching to be initiated; wherein said ranking occurs responsive to identifying occurrences of the targeted mentions and the search term together in instances of the content; wherein said ranking comprises determining, for a particular user of the set of users, weighted values for targeted mentions of the particular user, adding the weighted values to determine a targeted mentions score, and determining a correlation score for the particular user based at least in part on the targeted mentions score; wherein said ranking comprises: determining, for a particular user of the set of users, weighted values for targeted mentions of the particular user, and adding the weighted values to determine a targeted mentions score for the particular user; determining an auxiliary score for the particular user based on criteria other than targeted mentions of the particular user, the criteria pertaining to correlation of the particular user with the search term; and using the targeted mentions score and the auxiliary score to determine a correlation score for the particular user.

A method for generating a ranked set of users correlated with a search term, the method comprising: searching content, by a computing device, for targeted mentions of users, the targeted mentions corresponding to users that are linked to a search tag and correlated with a search term, the search tag being different than the search term; identifying within the content a set of users with targeted mentions correlated with the search term; calculating, by the computing device, a correlation score for each user of the set of users, said calculating being based at least in part on a number of targeted mentions for each user of the set of users; ranking the set of users based on respective correlation scores for each user; and outputting, based on said ranking, a ranked set of users that are correlated with the search term.

In addition to any of the above described methods, any one or combination of: wherein said calculating a correlation score for a particular user comprises: determining weighted values for targeted mentions of the particular user based on a number of targeted mentions of different users in instances of content in which the targeted mentions of the particular user are located; and adding the weighted values to obtain at least a portion of the correlation score; wherein said calculating a correlation score for a particular user comprises: determining weighted values for targeted mentions of the particular user based on a number of targeted mentions of different users in instances of content in which the targeted mentions of the particular user are located, a particular weighted value of a particular targeted mention being reduced from a standard weighting value based on a number of targeted mentions of different users that are included in an instance of the content for the particular targeted mention exceeding a threshold number of targeted mentions; and adding the weighted values to obtain at least a portion of the correlation score; wherein said calculating a correlation score for a particular user comprises: determining, for a particular user of the set of users, weighted values for targeted mentions of the particular user, and adding the weighted values to determine a targeted mentions score for the particular user; determining an auxiliary score for the particular user based on criteria other than targeted mentions of the particular user, the criteria pertaining to correlation of the particular user with the search term; and using the targeted mentions score and the auxiliary score to determine a correlation score for the particular user.

What is claimed is:

1. A system comprising:
one or more processors; and
one or more computer-readable storage media storing computer-executable instructions that, responsive to execution by the one or more processors, cause the system to perform operations including:
receiving a search query that includes a trigger phrase and a search term;
searching content, based on the trigger phrase, for targeted mentions of users, the targeted mentions corresponding to users that are linked to a search tag and correlated with the search term, the search tag being different than the search term;
identifying within the content a set of users with targeted mentions correlated with the search term;
ranking the set of users based on respective correlation scores for the users, the correlation scores based at least in part on a number of targeted mentions for individual users of the set of users; and
outputting, based on said ranking, a ranked set of users that are correlated with the search term.

2. The system as described in claim 1, wherein the content includes content posted to a network-based interactivity service.

3. The system as described in claim 1, wherein the content includes content posted to a network-based interactivity service, and wherein the search query is received via user input to the interactivity service.

4. The system as described in claim 1, wherein the content includes content posted to a network-based interactivity service, and wherein the search tag comprises a symbol appended to user identifiers for the users within body portions of the content.

5. The system as described in claim 1, wherein said searching comprises searching for the search tag appended to user identifiers for different users, the user identifiers being included in instances of the content that include the search term.

6. The system as described in claim 1, further comprising a search module that is configured to parse the search query to distinguish between the trigger phrase and the search term, and to recognize the trigger phrase as a request to initiate said searching.

7. The system as described in claim 1, wherein said identifying comprises identifying occurrences of the targeted mentions and the search term together in instances of the content.

8. The system as described in claim 1, wherein said ranking comprises determining, for a particular user of the set of users, weighted values for targeted mentions of the particular user, adding the weighted values to determine a targeted mentions score, and determining a correlation score for the particular user based at least in part on the targeted mentions score.

9. The system as described in claim 1, wherein said ranking comprises:
determining, for a particular user of the set of users, weighted values for targeted mentions of the particular user, a particular weighted value of a particular targeted mention being based on a number of targeted mentions of different users that are included in an instance of the content for the particular targeted mention; and
adding the weighted values to determine a targeted mentions score, and determining a correlation score for the particular user based at least in part on the targeted mentions score.

10. The system as described in claim 1, wherein said ranking comprises:
determining, for a particular user of the set of users, weighted values for targeted mentions of the particular user, a particular weighted value of a particular targeted mention being reduced from a standard weighting value based on a number of targeted mentions of different users that are included in an instance of the content for the particular targeted mention exceeding a threshold number of targeted mentions; and
adding the weighted values to determine a targeted mentions score, and determining a correlation score for the particular user based at least in part on the targeted mentions score.

11. The system as described in claim 1, wherein said ranking comprises:
determining, for a particular user of the set of users, weighted values for targeted mentions of the particular user, and adding the weighted values to determine a targeted mentions score for the particular user;
determining an auxiliary score for the particular user based on criteria other than targeted mentions of the particular user, the criteria pertaining to correlation of the particular user with the search term; and
using the targeted mentions score and the auxiliary score to determine a correlation score for the particular user.

12. A method comprising:
searching content, by a computing device, for targeted mentions of users, the targeted mentions corresponding to users that are linked to a search tag and correlated with a search term, the search tag being different than the search term;
ranking a set of users based on respective correlation scores for the users, the correlation scores based at least in part on a number of targeted mentions for individual users of the set of users; and
outputting, based on said ranking, a ranked set of users that are correlated with the search term.

13. The method as described in claim 12, wherein said searching is based on a search query that includes a trigger phrase and the search term, the trigger phrase causing said searching to be initiated.

14. The method as described in claim 12, wherein said ranking occurs responsive to identifying occurrences of the targeted mentions and the search term together in instances of the content.

15. The method as described in claim 12, wherein said ranking comprises determining, for a particular user of the set of users, weighted values for targeted mentions of the particular user, adding the weighted values to determine a targeted mentions score, and determining a correlation score for the particular user based at least in part on the targeted mentions score.

16. The method as described in claim 12, wherein said ranking comprises:
determining, for a particular user of the set of users, weighted values for targeted mentions of the particular user, and adding the weighted values to determine a targeted mentions score for the particular user;
determining an auxiliary score for the particular user based on criteria other than targeted mentions of the particular user, the criteria pertaining to correlation of the particular user with the search term; and
using the targeted mentions score and the auxiliary score to determine a correlation score for the particular user.

17. A method comprising:
searching content, by a computing device, for targeted mentions of users, the targeted mentions corresponding to users that are linked to a search tag and correlated with a search term, the search tag being different than the search term;
identifying within the content a set of users with targeted mentions correlated with the search term;
calculating, by the computing device, a correlation score for each user of the set of users, said calculating being based at least in part on a number of targeted mentions for each user of the set of users;
ranking the set of users based on respective correlation scores for each user; and
outputting, based on said ranking, a ranked set of users that are correlated with the search term.

18. The method as described in claim 17, wherein said calculating a correlation score for a particular user comprises:
determining weighted values for targeted mentions of the particular user based on a number of targeted mentions of different users in instances of content in which the targeted mentions of the particular user are located; and
adding the weighted values to obtain at least a portion of the correlation score.

19. The method as described in claim 17, wherein said calculating a correlation score for a particular user comprises:
determining weighted values for targeted mentions of the particular user based on a number of targeted mentions of different users in instances of content in which the targeted mentions of the particular user are located, a particular weighted value of a particular targeted mention being reduced from a standard weighting value based on a number of targeted mentions of different users that are included in an instance of the content for the particular targeted mention exceeding a threshold number of targeted mentions; and
adding the weighted values to obtain at least a portion of the correlation score.

20. The method as described in claim 17, wherein said calculating a correlation score for a particular user comprises:
determining, for a particular user of the set of users, weighted values for targeted mentions of the particular user, and adding the weighted values to determine a targeted mentions score for the particular user;
determining an auxiliary score for the particular user based on criteria other than targeted mentions of the particular user, the criteria pertaining to correlation of the particular user with the search term; and
using the targeted mentions score and the auxiliary score to determine a correlation score for the particular user.
